(19) United States
(12) Patent Application Publication
(10) Pub. No.: US 2026/0030889 A1
(43) Pub. Date: Jan. 29, 2026

(54) APPARATUS AND METHOD FOR MONITORING FIT-OUT IN CONSTRUCTION SITES

(71) Applicant: Chun Wo Construction & Engineering Co., Ltd., Hong Kong (HK)

(72) Inventor: Derrick Yat Bond PANG, Hong Kong (HK)

(21) Appl. No.: 18/783,454

(22) Filed: Jul. 25, 2024

(51) Int. Cl. G06V 20/52; G06V 10/764; G06V 20/40; G06V 20/60

(52) U.S. Cl. CPC G06V 20/52; G06V 10/764; G06V 20/41; G06V 20/60

(57) ABSTRACT

A monitoring system for fit-out in a construction site is provided. The monitoring system includes at least one camera, a network video recorder, a first identifying module, and a display. The camera captures at least one video. The network video recorder electrically communicates with the camera to receive the video from the camera. The first identifying module electrically communicates with the network video recorder and is configured to: detect at least one pattern or texture of an object surface from frames of the video; analyze at least one texture or pattern of the object surface from a perspective of interior finishes; and determine work progress of fit-out at construction sites in response to an analysis result with respect to the pattern or texture of the object surface. The display electrically communicates with the first identifying module and is configured to show a dashboard with the work progress of the fit-out.

### FIELD OF THE INVENTION

The present invention relates to an artificial intelligence-based (AI-based) system for monitoring interior fit-out works in construction sites.

### BACKGROUND OF THE INVENTION

In the field of construction site monitoring, several state-of-the-art systems have been developed to enhance safety and security. These systems often rely on traditional surveillance cameras or manual monitoring methods, which have limitations in terms of real-time analysis and accuracy. Additionally, the processing of vast amounts of video data can be time-consuming. Furthermore, manual monitoring is subject to human error and limitations, making it challenging to ensure comprehensive and reliable coverage of construction sites.

There is an obvious need for an advanced monitoring technique that can address these shortcomings and provide more efficient and accurate monitoring capabilities. However, many of the existing systems have focused primarily on basic motion analysis. While they have shown promising results, there are potential high costs associated, such as hiring personnel for monitoring, and real-time progress recording. Accurately selecting the target object to be monitored is another issue, as misidentification can result in distorted detection with high odds.

Accordingly, there are critical issues to be solved, and an effective algorithm for video analytics is needed to address these challenges.

### SUMMARY OF THE INVENTION

It is an objective of the present invention to provide a monitoring system and a monitoring method to address the aforementioned issues in the prior arts.

In accordance with a first aspect of the present invention, a monitoring system for fit-out at construction sites is provided. The monitoring system includes at least one camera, a network video recorder, a first identifying module, and a display. The camera is configured to capture at least one video. The network video recorder electrically communicates with the camera to receive the video from the camera. The first identifying module electrically communicates with the network video recorder and is configured to: detect at least one pattern or texture of an object surface from frames of the video; analyze at least one texture or pattern of the object surface from a perspective view of interior finishes; and determine work progress of fit-out at construction sites in response to an analysis result with respect to the pattern or texture of the object surface. The display electrically communicates with the first identifying module and is configured to show a dashboard with the work progress of the fit-out.

In accordance with a second aspect of the present invention, a monitoring method for fit-out at construction sites is provided. The monitoring method includes steps: capturing at least one video via at least one camera; transferring the video from the camera to a network video recorder; detecting at least one pattern or texture of an object surface from frames of the video via a first identifying module; analyze at least one texture or pattern of the object surface, via the first identifying module, from a perspective of interior finishes; determining work progress of fit-out at construction sites, via the first identifying module, in response to an analysis result with respect to the pattern or texture of the object surface; and displaying an virtual dashboard on the work progress of the fit-out via an electronic display.

By the above configuration, the monitoring system of the present invention performs the monitoring process, monitoring fit-out work progress through the analysis of visual features extracted from video frames. Moreover, the monitoring system exhibits accurate recognition of label patterns and provides information regarding the distribution of workers among various sub-contractors.

### BRIEF DESCRIPTION OF THE DRAWINGS

Embodiments of the invention are described in more details hereinafter with reference to the drawings, in which:

FIG. 1 depicts a schematic diagram of a monitoring system for fit-out at construction sites in accordance with various embodiments of the present invention;

FIG. 2A and FIG. 2B depict some exemplary video frames containing features associated with interior finishes according to various embodiments of the present invention;

FIG. 3 illustrates some exemplary features related to the label classification according to various embodiments of the present invention;

FIG. 4 depicts a schematic diagram of an infrastructure of an AI system implemented into the AI-based video recognition engine according to various embodiments of the present invention; and

FIG. 5 depicts a flowchart of a monitoring method for fit-out at construction sites in accordance with various embodiments of the present invention.

### DETAILED DESCRIPTION

In the following description, apparatuses, systems, and/or methods for monitoring fit-out at construction sites and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

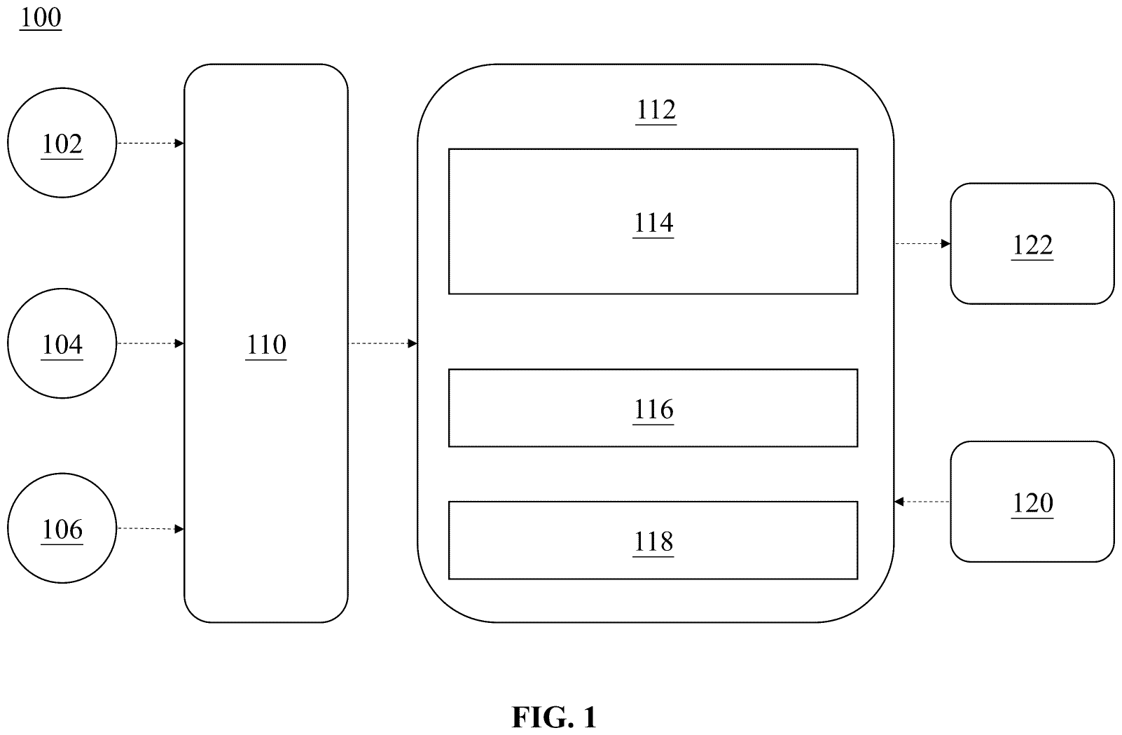

FIG. 1 depicts a schematic diagram of a monitoring system 100 for fit-out at construction sites in accordance with various embodiments of the present invention. The monitoring system 100 is configured to detect, recognize, and then analyze the objects, patterns, and textures related to interior fit-out works at construction sites. This includes assessing fit-out progress, such as the degree of wall painting, and identifying resources, such as the number of workers from different sub-contractors. The monitoring system 100 includes cameras 102, 104, 106, a network video recorder (NVR) 110, an AI-based video recognition engine 112, a user interface 120, and a display 122.

The cameras 102, 104, 106 are configured to capture at least one video or video footage in one or more construction sites. These cameras 102, 104, 106 can be strategically placed in a single or multiple construction sites, providing different viewing angles and comprehensive coverage of the construction areas. The number of the cameras can vary based on the specific needs of the project, ensuring that all crucial areas and activities are captured for real-time monitoring and analysis.

The NVR 110 electrically communicates with the cameras 102, 104, and 106 and is configured to receive video feeds from them. The captured videos are then transmitted to the NVR 110 for further processing and analysis, enabling accurate assessment of fit-out progress and resource identification. The NVR 110 acts as a central point of connection for devices, receiving captured image/video signal data from the cameras 102, 104, and 106 and forwarding them to their intended recipients. In various embodiments, the NVR 110 may include a network switch, which is a networking device used to connect multiple devices within a local area network.

The AI-based video recognition engine 112 electrically communicates with the NVR 110 and functions as a backend system for assessing the fit-out progress and identifying the resources. The AI-based video recognition engine 112 includes a database 114, a first identifying module 116, and a second identifying module 118. The AI-based video recognition engine 112 can be implemented using a combination of a network-attached storage device and a processor, providing capabilities such as data analysis, data backup, data synchronization, remote access, and media streaming.

The database 114 stores a plurality of images at least related to interior finishes and label classification. Regarding interior finishes, the images may contain wall surface decorations, such as wall patterns and textures, as well as patterns and textures used for decorative designs. The images applied in the present invention are not limited to the wall surface decorations. For example, in various embodiments, the images stored in the database 114 may be related to door installation such as door patterns and textures, window frame installation such as window frame colors and shapes, or other interior fit-out work which can be captured as characteristic skins, or the likes; even changes in the surface morphology or appearance of waterproof materials/waterproof coatings; or tiles used in interior decoration. Regarding label classification, the images may contain logos belonging to sub-contractors, which may encompass geometric patterns and numbers.

The first identifying module 116 is designed to utilize one or more machine learning (ML) algorithms, such as the various deep neural networks (DNN) and convolutional neural networks (CNN), trained with images of interior finishes of various stages of fit-out progress, to detect and classify from the frames of the video features associated with interior finishes. As such, the first identifying module 116 analyzes the patterns, textures, and designs of artifacts using a ML-based approach that enables object detection by dividing a video frame into a grid and predicting bounding boxes and class probabilities directly from the grid. In one embodiment, the first identifying module 116 performs real-time object detection using the ML-based approach. In another embodiment, the first identifying module 116 performs object detection with latency using the ML-based approach, such as a 0.5 day latency, for work progression detection. In various embodiments, this module establishes a connection with the database 114, enabling it to accurately identify and classify visual features extracted from the video frames. Through extensive training and comparison with the database 114, the first identifying module 116 becomes proficient at recognizing specific patterns, textures, and designs of artifacts associating with the various stages of fit-out progress in a construction site. The first identifying module 116 can precisely determine the work progress by analyzing the results derived from the identified features of the video frames.

The second identifying module 118 is designed to utilize one or more ML algorithms, such as the various DNNs and CNNs, trained with images of names and logos of companies and organizations, and personnel identification label text and numbers associated with the construction business, to detect and classify from the frames of the video for the purpose of identifying features from worker's badges related to label classification. In various embodiments, this module establishes a connection with the database 114, enabling it to accurately identify and classify visual features extracted from the video frames. Through extensive training and comparison with the database 114, the second identifying module 118 becomes proficient at recognizing label classification features, allowing it to determine the number of workers and recognize to which contractor or sub-contractor companies or organizations they belong in the construction sites based on the analysis results derived from these features. In one embodiment, the second identifying module 118 performs real-time worker detection. In another embodiment, the second identifying module 118 performs worker detection with latency, such as a 0.5 day latency, for subcontractor worker number detection.

In embodiments related to identifying modules utilizing ML algorithms, to detect and classify the features present in the frames of the video, the trainings of the ML algorithms involve several steps to ensure accurate feature detection and classification. In the initially learning phase, the identifying modules are trained with training data comprising a vast collection of images, allowing the modules to learn the different visual patterns and characteristics of interior finishes and worker's badge labels respectively. After the learning, the identifying modules undergo an assessment phase where their performances are assessed based on predefined metrics and benchmarks. In the assessment phase, areas of improvement are identified so to guide subsequent fine-tuning step. In the fine-tuning phase, the parameters and algorithms of the ML models of the identifying modules are refined by minimizing their respective loss functions so to enhance their prediction accuracies (i.e., abilities to recognize and analyze specific features related to their respective desired tasks). Through iterations of learning, assessment, and fine-tuning, the identifying modules become adept at capturing intricate details and patterns within the images, enabling precise analysis and accurate identification of relevant features. This iterative learning process ensures that the module adapts to various scenarios and provides reliable results when applied to real-world images in the context of fit-out progress monitoring and resource identification in a construction site. The identifying module/model learns patterns and features from the training data to make predictions or perform specific tasks. It generalizes from the training data to make predictions on previously unseen data. The identifying module/model can be saved as a file or a set of files that can be deployed and used for inference on new data and be further applied to cooperation with other physical components.

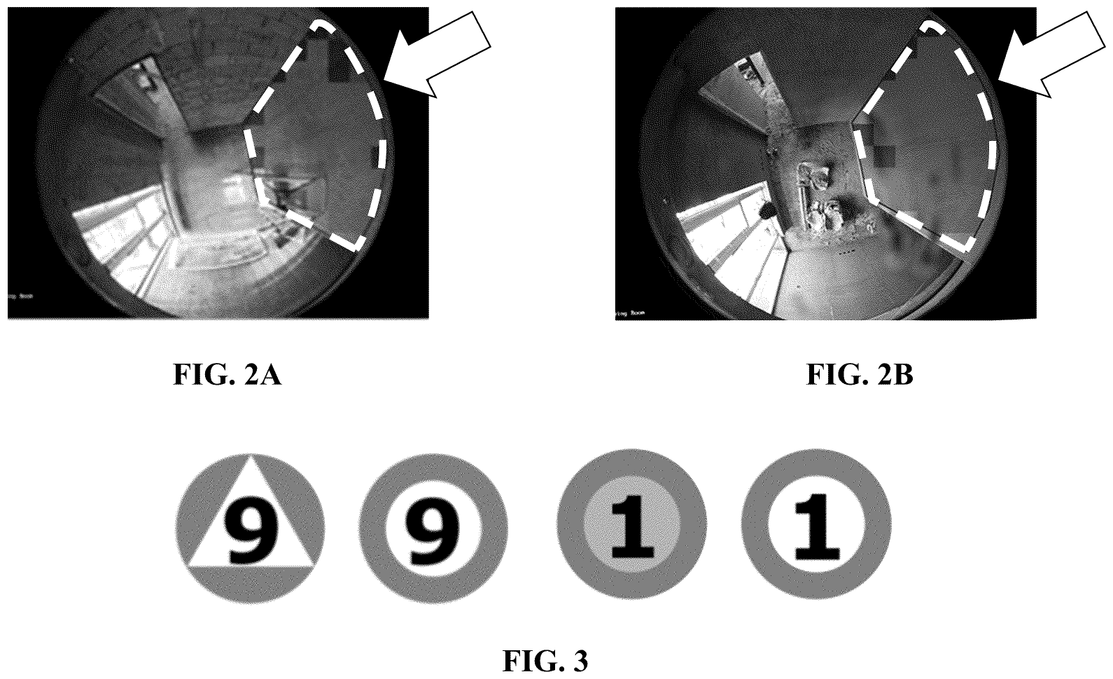

FIG. 2A and FIG. 2B depict exemplary frames of a video containing features associated with interior finishes according to various embodiments of the present invention, FIG. 3 depicts exemplary features related to label classification according to various embodiments of the present invention.

As depicted in FIG. 2A and FIG. 2B, when an image (i.e., at least one frame of a video) is captured by the camera and fed into the first identifying module 116, the distinctive features of the specific work trade, indicated by the arrow, are quantified, recognized, and analyzed by the first identifying module 116. This enables the module to track and determine the overall work progress of the fit-out. For instance, in FIG. 2A, which represents the work progress on day 1, the first identifying module 116 detects and analyzes the texture of the wall surface, classifying that 30% of the total work progress has been completed. In FIG. 2B, which illustrates the work progress on day 3, the first identifying module 116 detects and analyzes the texture of the same wall surface as seen in FIG. 2A, classifying that 45% of the total work progress has been accomplished. In one embodiment, the first identifying module 116 is enabled to track and determine daily work progress completion of the fit-out. By accurately quantifying and analyzing the specific visual features, the first identifying module 116 enables precise tracking and monitoring of the fit-out progress over time, providing valuable insights for effective project management and resource allocation.

As depicted in FIG. 3, in various embodiments, the logo as afore-mentioned may possess three distinct features that aid in label classification and identification. Firstly, with respect to those two with number 9, the logo may include an inter outline, which can take the form of shapes such as circles, triangles, rectangles, or other similar geometrical structures. Secondly, with respect to those two with number 1, the color of the logo within the inter outline serves as another distinguishing characteristic. Lastly, the logo may include a number displayed within the inter outline, providing an additional element for differentiation. By considering these three features (i.e., the shape, color, and number), the second identifying module 118 accurately detects and classifies logos belonging to different contractor or sub-contractor companies, which can be used for tracking the number of sub-contractors, facilitating effective resource identification and management on construction sites.

The database 114 stores extensive collection of images with such the relevant features. These images serve as training data for the first identifying module 116 and the second identifying module 118. In one embodiment, the database 114 is designed to be updatable, allowing for continuous learning for the identifying modules. As the database 114 receives updates, the first identifying module 116 and the second identifying module 118 are retrained to further refine their recognition abilities, leading to improved performance over time.

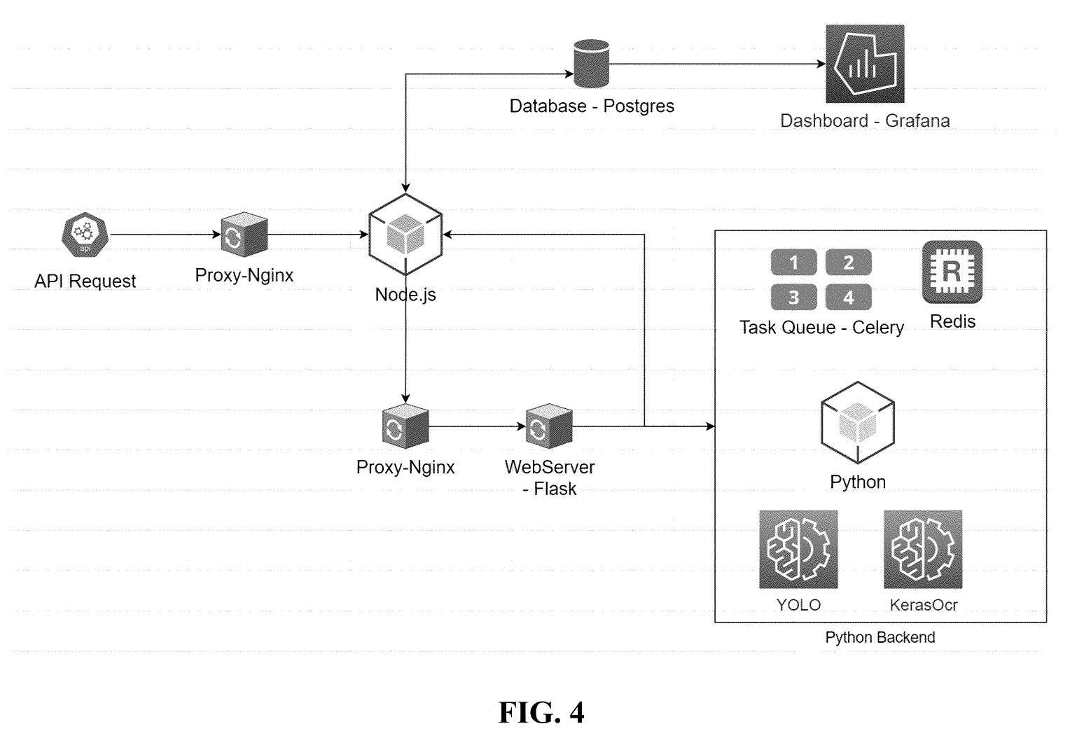

In one embodiment, the AI-based video recognition engine 112 is implemented as an AI system having an infrastructure as illustrated in FIG. 4. The process starts with an API request function which is directed to a Proxy-Nginx server. The request is then passed to a Node.js server, where data processing and handling take place. The Node.js server interacts with a Database-Postgres function, indicating data retrieval and storage. The retrieved data is visualized in a Dashboard-Grafana for monitoring and analysis purposes. Additionally, the Node.js server connects to another Proxy-Nginx server, which further directs the flow to a Webserver-Flask function. The Webserver-Flask function serves as a front-end interface for user interaction. From there, then it leads to a Python Backend block that encompasses various components, including a Task Queue-Celery function for managing asynchronous tasks, a Redis function for caching and data storage, a Python function for executing scripts and logic, a YOLO function for object detection, and a KerasOcr function for optical character recognition. This architecture enables efficient data processing, storage, visualization, and integration of multiple technologies for a comprehensive system solution. The above system architecture is provided solely as an example, and it is well within the knowledge of those skilled in the art to assemble systems with different architectures to achieve the aforementioned objectives after reading the teachings as above in the present disclosure.

Referring again to FIG. 1, the user interface 120 establishes electrical communication with the AI-based video recognition engine 112, enabling remote control and management. Users can conveniently control the AI-based video recognition engine 112 and the cameras 102, 104, 106 through the user interface 120, allowing for real-time monitoring, adjustment of settings, and access to valuable information. This intuitive and user-friendly interface enhances the usability of the system, enabling efficient remote management and decision-making without the need for physical presence in the construction sites.

The display 122 is in electrical communication with both the first identifying module 116 and the second identifying module 118 of the AI-based video recognition engine 112. It is specifically configured to present a virtual dashboard that provides visual information regarding the work progress of the fit-out as well as details about the workers, including different worker groups. The virtual dashboard allows users to conveniently access and monitor the real-time status of the fit-out progress and the corresponding worker information.

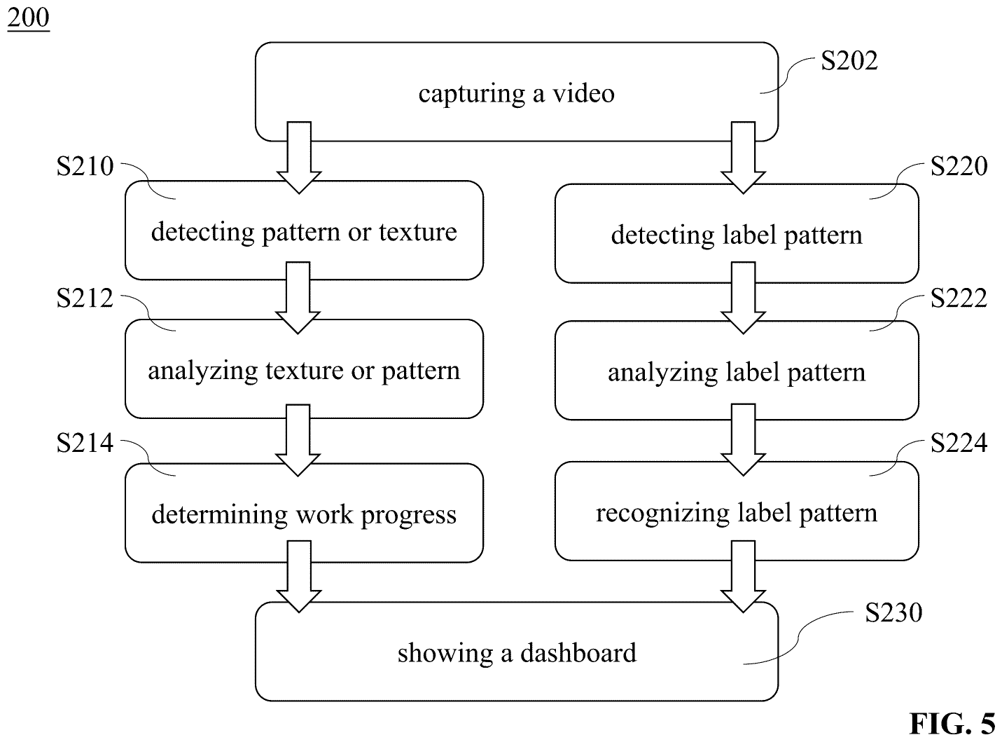

FIG. 5 depicts a flowchart of a monitoring method 200 for fit-out in the construction sites in accordance with various embodiments of the present invention, in which the monitoring system 100 performs the process of the monitoring method 200 as illustrated in FIG. 5. The monitoring method 200 includes steps S202, S210, S212, S214, S220, S222, S224, and S230.

In the step S202, at least one video on site is captured by the camaras 102, 104, 106 and transferred to the NVR 110. The captured video then can be fed into the AI-based video recognition engine 112 for further analyzing. In various embodiments, the NVR 110 can upload full day video to the AI-based video recognition engine 112 in night time via wire or wireless communication.

The steps S210, S212, and S214 are involved in the process of interior finish recognition. In the step S210, the first identifying module 116 detects at least one pattern or texture from the frames of the video, which is related to the object surface. In the step S212, the first identifying module 116 analyzes at least one feature of the detected texture or pattern, from a perspective of interior finishes. In another embodiment, the first identifying module 116 analyzes at least one feature of the detected texture or pattern according to the images stored in the database 114. In the step S214, the first identifying module 116 determines the work progress of fit-out in the construction sites based on an analysis result obtained in the step S212.

The steps S220, S222, and S224 are involved in the process of label classification. In the step S220, the second identifying module 118 detects at least one label pattern from badges worn on the workers in the frames of the video. In the step S222, the second identifying module 118 analyzes at least one feature of the detected label pattern, from a perspective of label classification with geometric patterns and number. In another embodiment, the second identifying module 118 analyzes at least one feature of the detected label pattern according to the images stored in the database 114. In the step S224, the second identifying module 118 recognizes the resource (e.g., contractor or sub-contractor companies) to which the label pattern belongs, based on the analysis result obtained in the step S222. Additionally, in the step S224, the second identifying module 118 counts the number of label patterns and classifies them into distinct groups, indicating the quantity of workers from the different contractor and/or sub-contractor companies.

Subsequently, in the step S230, the outcomes derived from the steps S214 and S224 are visualized and presented on the dashboard of display 122. In one embodiment, the dashboard provides a comprehensive overview, displaying the total work progress of the fit-out, the number of workers in a time period, and the corresponding contractor and/or sub-contractor companies to which they belong. In another embodiment, users can switch a certain time window; for example, user can select to show the information on the dashboard of display 122 by daily, weekly, monthly or certain period of time they selected. This visual representation on the display 122 enables administrators to conveniently monitor and track crucial information, facilitating effective decision-making and management of the fit-out process in the construction sites.

As described above, the approach of the present invention can be divided a video captured part, a backend part, and a frontend part. The captured video can be fed into the backend part from the video captured part for further analyzing. The analyzing result can be visualized and shown via the frontend part to inform users. The monitoring system of the present invention performs the monitoring process, monitoring fit-out work progress through the analysis of visual features extracted from video frames. This capability significantly enhances the effectiveness of monitoring and managing the construction process. Furthermore, the monitoring system exhibits accurate recognition of label patterns and provides information regarding the distribution of workers among various sub-contractors.

The functional units and modules of the apparatuses, systems, and/or methods in accordance with the embodiments disclosed herein may be implemented using computer processors or electronic circuitries including but not limited to application specific integrated circuits (ASIC), field programmable gate arrays (FPGA), microcontrollers, and other programmable logic teaching aids configured or programmed according to the teachings of the present disclosure. Computer instructions or software codes running in the computing teaching aids, computer processors, or programmable logic teaching aids can readily be prepared by practitioners skilled in the software or electronic art based on the teachings of the present disclosure.

The embodiments may include computer storage media, transient and non-transient memory teaching aids having computer instructions or software codes stored therein, which can be used to program or configure the computing teaching aids, computer processors, or electronic circuitries to perform any of the processes of the present invention. The storage media, transient and non-transient memory teaching aids can include, but are not limited to, floppy disks, optical discs, Blu-ray Disc, DVD, CD-ROMs, and magneto-optical disks, ROMs, RAMs, flash memory teaching aids, or any type of media or teaching aids suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing teaching aids interconnected by a communication network, such as an intranet, Wide Area Network (WAN), Local Area Network (LAN), the Internet, and other forms of data transmission medium.

In the present disclosure, the term “electrical communication” or the likes (e.g., “electrically communicating with”) include directly electrical communication and indirectly electrical communication. For example, in a configuration of that an element A is in electrical communication with an element B, it means the element A can directly couple with the element B, such as directly sending a signal from the element A to the element B; or, it also means the element A can indirectly couple with the element B, such as one or more bridge elements arranged between the element A and the element B.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A monitoring system for fit-out in one or more construction sites, comprising:
at least one camera configured to capture at least one video;
a network video recorder electrically communicating with the camera to receive the video from the camera;
a first identifying module electrically communicating with the network video recorder and configured to:
detect at least one pattern or texture of an object surface from frames of the video;
analyze at least one texture or pattern of the object surface from a perspective of interior finishes; and
determine work progress of fit-out in the construction sites in response to an analysis result with respect to the pattern or texture of the object surface; and
a display electrically communicating with the first identifying module and configured to show a dashboard with the work progress of the fit-out.

2. The monitoring system of claim 1, further comprising a second identifying module electrically communicating with the network video recorder and configured to:
detect at least one label pattern from the frames of the video;
analyze the label pattern from a perspective of label classification with geometric patterns and number; and
recognize to which resource the label pattern belongs in response to an analysis result with respect to the label pattern, wherein the display further shows the resource on the dashboard.

3. The monitoring system of claim 2, wherein the second identifying module is further configured to:
count the number of the label patterns; and
classify the label patterns into different groups, wherein the display further shows the different groups on the dashboard.

4. The monitoring system of claim 1, wherein the object surface includes a wall surface, and the first identifying module is further configured to determine the work progress of the fit-out per day.

5. The monitoring system of claim 1, wherein the first identifying module analyzes the texture or pattern of the object surface using a deep learning-based approach that enables real-time object detection with dividing at least one frame of the video into a grid and predicting bounding boxes and class probabilities directly from the grid.

6. A monitoring method for fit-out in one or more construction sites, comprising:
capturing at least one video via at least one camera;
transferring the video from the camera to a network video recorder;
detecting at least one pattern or texture of an object surface from frames of the video via a first identifying module;
analyze at least one texture or pattern of the object surface, via the first identifying module, from a perspective of interior finishes;
determining work progress of fit-out in the construction sites, via the first identifying module, in response to an analysis result with respect to the pattern or texture of the object surface; and
showing a dashboard with the work progress of the fit-out via a display.

7. The monitoring method of claim 6, further comprising:
detecting at least one label pattern from the frames of the video via a second identifying module;
analyzing the label pattern, via the second identifying module, from a perspective of label classification with geometric patterns and number; and
recognizing, via the second identifying module, to which resource the label pattern belongs in response to an analysis result with respect to the label pattern, wherein the display further shows the resource on the dashboard.

8. The monitoring method of claim 7, further comprising:
counting the number of the label patterns via the second identifying module; and
classifying the label patterns into different groups via the second identifying module, wherein the display further shows the different groups on the dashboard.

9. The monitoring method of claim 6, wherein the object surface includes a wall surface, and the monitoring method further comprises determining the work progress of the fit-out per day via the first identifying module.

10. The monitoring method of claim 6, wherein the first identifying module analyzes the texture or pattern of the object surface using a deep learning-based approach that enables real-time object detection with dividing at least one frame of the video into a grid and predicting bounding boxes and class probabilities directly from the grid.
